(19) United States
(12) Patent Application Publication
(10) Pub. No.: US 2007/0268788 A1
(43) Pub. Date: Nov. 22, 2007

(54) Watch

(76) Inventor: Antonio Perez, Les Brenets (CH)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/589,757

(22) PCT Filed: Feb. 22, 2005
(86) PCT No.: PCT/CH05/00102

§ 371 Date: Aug. 17, 2006

(30) Foreign Application Priority Data
Feb. 23, 2004 (CH) 294/04

(51) Int. Cl. G04B 37/06

(52) U.S. Cl. 368/319

(57) ABSTRACT

A watch is provided in which a movement pivots in a case and comprises a mechanism for correcting display organs. In one implementation of the watch, an assembly member is constructed such that, in at least one predefined position, the movement occupies a defined position in the case. Moreover, a control system is provided which comprises a button accessible from outside of the case, a stem attached to the button and passing through the case, and a connecting member designed to connect the button to the correcting mechanism and constructed in such a way that, in the defined position, it can be connected to the stem.

The present invention relates to watches having a case defining a housing and a movement arranged inside the housing and depicting a moving scene. It relates more particularly to watches in which the movement is able to move in its housing.

A watch of this kind is described in document CH 138,927. The movement is fixed in the case at an eccentric point with respect to its centre of gravity and is therefore able to oscillate freely when a force is applied to it. This motion winds up the mainspring. The information given in that document does not reveal how the display is corrected.

A similar solution is described in document CH 141,094. In that watch it is proposed to make a slit in the case through which a hand-setting stem is engaged and moves laterally when the movement moves. With such a solution the watch cannot be sealed.

It is an object of the present invention to enable the manufacture of watches in which the movement is able to move in its housing and in which the hands can be set easily and accurately, whilst still enabling the manufacture of a construction in which the case is sealed.

To this end, the watch according to the invention comprises:
a case defining a housing,
a movement arranged inside the housing,
display means carried by the movement,
an assembly member connecting the movement to the case, and
a control system accessible from outside the case for correcting the display means.

In this watch, the assembly member is constructed in such a way as to allow the movement to be displaced with reference to the case, and the movement comprises means for correcting the display means.

According to the invention, the assembly member is so constructed that, in at least one predefined position of the watch, the movement occupies a defined position in its housing. Moreover, the control system comprises:
a button accessible from outside the case,
a stem attached to the button and passing through the case, and
a connecting member designed to connect the button to the correcting means and constructed in such a way that, in the defined position of the movement, it can be connected to the stem.

Advantageously, the assembly member is constructed in such a way as to allow the movement to rotate in its housing.

Because the movement is of automatic type, its rotation winds up its driving spring.

In order to obtain an eccentric mass great enough to generate the required movements, the movement is encircled by a weighted ring.

In one particularly advantageous embodiment, the control member comprises a hand-setting stem engaging with the watch correcting mechanism and a connecting piece that is flush with said ring and has a flared portion such as to guide the stem attached to the button so that it engages in the connecting piece.

In order to seal the case, the latter has a tube engaging with the button and with the stem attached to the button, and, between the button and the tube, a seal for sealing the passage of the stem through the case.

Other features and advantages of the invention will become apparent in the course of the following description, which refers to the appended drawing in which:

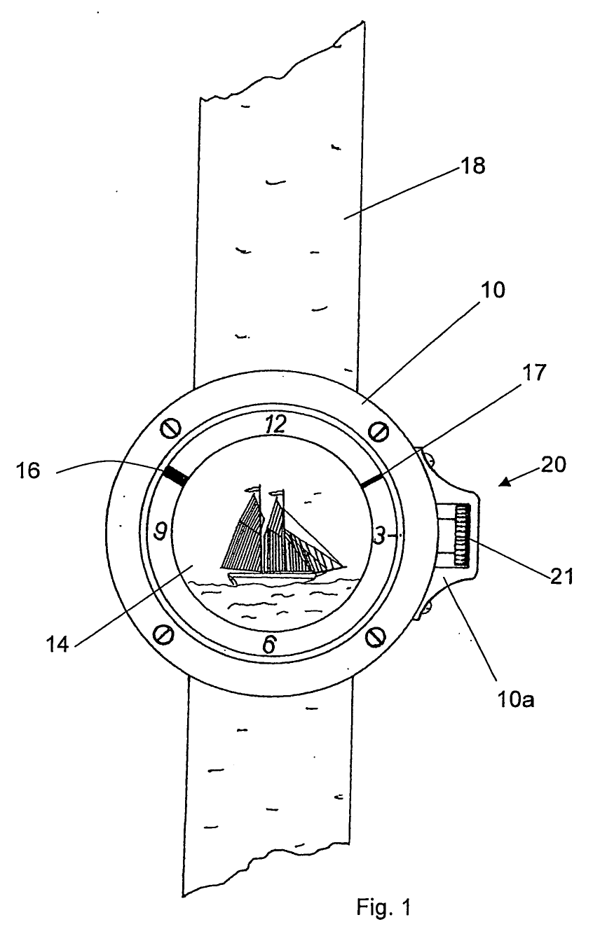

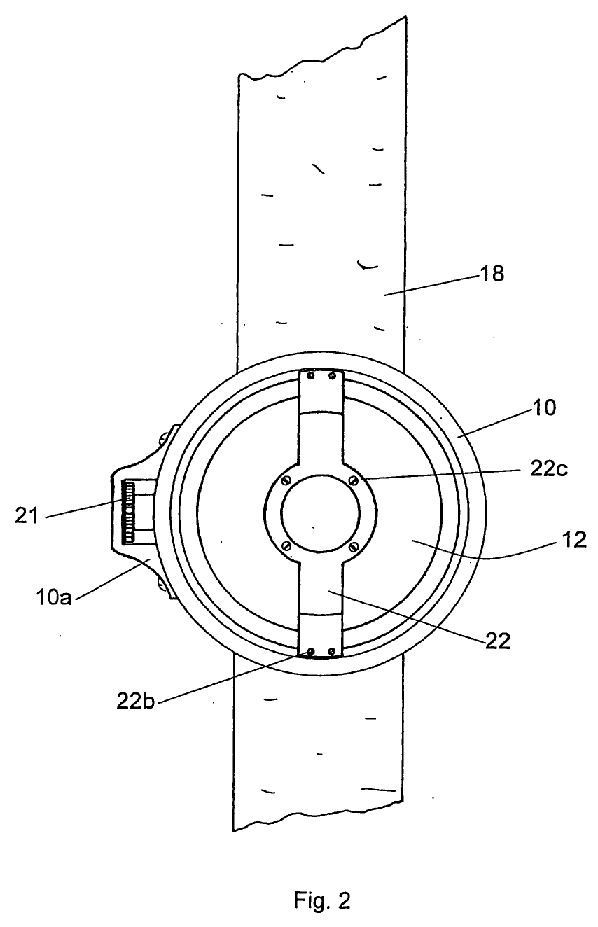

FIGS. 1 and 2 show a watch according to the invention in a top view, and in a bottom view with the back removed respectively;

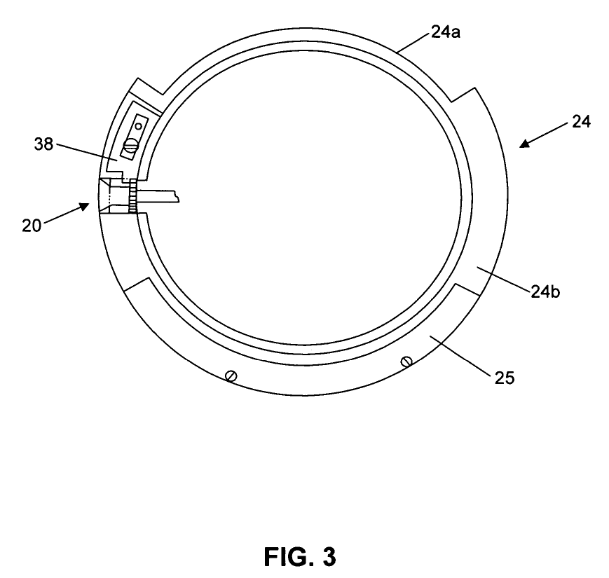

FIG. 3 shows schematically the movement of the watch of FIGS. 1 and 2; and

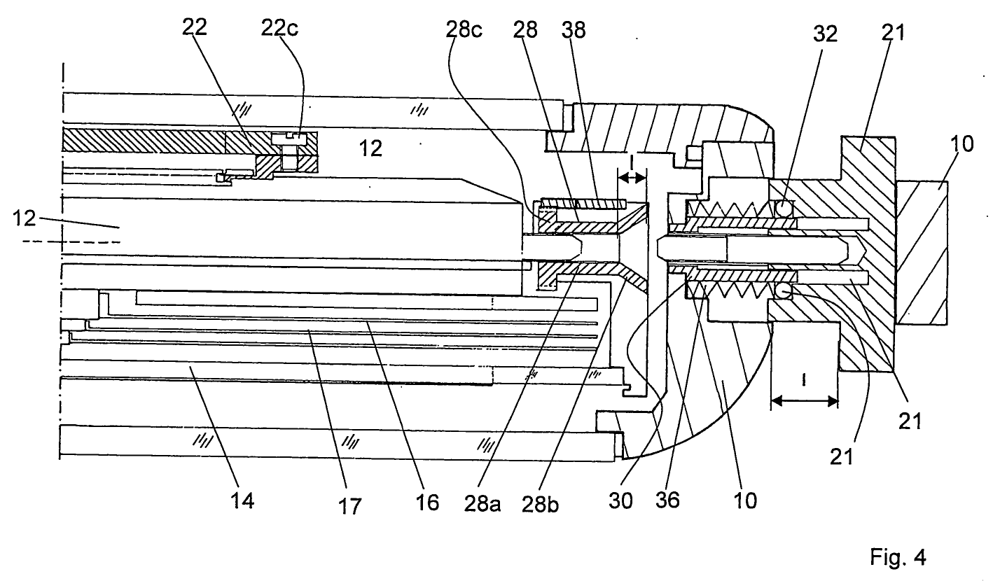

FIG. 4 is a cross section through the part of the watch that connects the correcting means to the outside of the case.

The watch shown in FIG. 1 comprises, conventionally:
a case 10 defining a housing,
a movement 12 arranged in the housing,
display means comprising a dial 14 and hands 16 and 17,
a wristband 18, and
a control system 20, of which only a hand-setting crown providing a control button function 21 is visible in FIG. 1 and which will be described in greater detail below.

Screwed to the edge of the case 10 is a bow 10a covering the button 21.

The movement 12 advantageously has an automatic winding mechanism employing an oscillating mass, which has been modified to keep only its plate shown schematically at 12a.

An assembly member 22 positions the movement 12 in the housing of the case 10. It has a bridge 22a and screws 22b and 22c attaching the bridge 22a to the case 10 and to the plate 12a respectively. The movement 12 is thus able to rotate in its housing about the pivot axis of the plate 12a.

As FIGS. 3 and 4 show more particularly, a ring 24 encircles the movement 12. The ring has two distinct arcs each occupying an angle of approximately 180°, a thin arc 24a and a thick arc 24b, thus forming an eccentric mass. The arc 24b also carries a weight 25 to reinforce the eccentric mass.

The watch described above consequently allows the movement to be seen as it oscillates inside the case 10, the ship depicted on the dial 14 giving the impression of pitching.

The control system 20, which will be described in greater detail hereunder, can be used to correct the display when the 6 o'clock-12 o'clock axis of the dial 14 is aligned with the axis of the wristband 18. In this position, and as will be explained later, the button 21 can be screwed onto the movement 12 and then pulled.

In the pulled position, the display can be corrected in the ordinary way. After pushing the button 21 back again, a counterclockwise rotation unscrews the button 21, which will then resume its initial position.

The control system 20 comprises, integral with the movement, a conventional hand-setting mechanism equipped with a hand-setting stem 26, of which the only part visible in FIGS. 2, 3 and 4 is the end external to the movement. This end is fitted with a funnel-shaped piece 28 which is pierced from end to end and comprises a cylindrical portion 28a and a flared portion 28b which is flush with the ring 24. This piece 28, as will be explained below, acts as a connecting member.

The inside wall of the cylindrical portion 28a provides a housing for the end of the stem 26 along part of its length. It is fixed rigidly to the latter by press fitting or adhesive bonding or the like. The other part, adjoining the flared portion 28b, is tapped. The cylindrical portion is also provided with teeth 28c whose function will be explained later.

As can be seen in more detail in FIG. 4, the case 10 is provided with a tube 30 providing a passage out of the case 10.

The button 21 has an annular groove 21a in which the tube 30 is engaged. A recess 21b runs around the opening of the groove 21a, forming a housing for an O-ring 32. It is also drilled with a blind hole coaxial with the groove 21a, in which a threaded stem 34 is mounted.

A compression spring 36 around the outside of the tube 30 is interposed between the case 10 and the button 21. It tends to push the latter back against the bow 10a.

A click 38 on the ring 24 engages with the teeth 28c to prevent the stem 26 and the connecting piece 28 turning counterclockwise.

The ring 24 and the weight 25 are of such dimensions and so positioned that the connecting piece 28 is adjacent to the stem 34 when the axis of the wristband is oriented vertically. In this position, since the bow 10a is turned towards the right, pressure on the button 21 will push the stem 34 into the flared portion 28b.

Turning the button 21 screws the stem 34 into the tapped part of the portion 28a and thus connects the button 21 to the hand-setting stem 26. It is the friction created by the click 38 on the teeth 28c which makes this screwing action possible.

In order for engagement to be possible, the possible axial movement of the button 21, indicated by the dimension L, must be greater than the distance, marked by the dimension 1, between the threaded end of the stem 34 and the tapped part of the cylindrical portion 28a.

With the stem 34 now screwed into the connecting piece 28, the stem 26 is also rotated and therefore winds the watch spring. In this condition, pulling the button 21 pulls the hand-setting stem 26 into the correcting position. The button 21 can therefore be rotated in the clockwise direction and, with it, the hand-setting stem 26, which drives the hand-setting mechanism.

When the correction is completed, the button 21 is pushed in again and, along with it, the stems 26 and 34 connected by the connecting piece 28. The button 21 is then rotated in the counterclockwise direction, unscrewing the stem 34 from the connecting piece 28. When the button 21 is released it is pushed back out with the stem 34 by the spring 36, thus breaking the connection between the button 21 and the movement 12. The movement can now rotate freely again.

Numerous variants can of course be made of the watch described above. The click 38 could be replaced with a locking device preventing the stem 26 from rotating when pushed in and freeing it completely when pulled out. In this case the watch is wound by the automatic mechanism only, and the hands can be corrected in either direction.

It would also be possible to have a locked position only when the button 21 is pushed in, the lock releasing the teeth 28c as soon as the pressure is removed, and the spring 36 withdrawing the teeth 28c from the lock.

The button 21 may be held axially by other means than the bow 10a, for instance by a key located inside the case 10 and engaged on the stem 34. In this case the stem 34 would need to be lengthened.

The stem 34 and the connecting piece 28 are screwed to each other. Clearly, a bayonet connection is also applicable.

In the example given, the hands are corrected by means of a winding crown type button. Another possibility is to envisage correction by means of a pushbutton. This is particularly the case if the movement is an electronic one.

It will be seen too that a watch of this construction can be worn equally well on either the left arm or the right arm without causing any difficulty in reading the time, twelve o'clock always being at the top regardless of how it is worn on the arm.

Lastly, it will be seen that, because of its rotation in the case, the movement occupies a vertical position which is always the same. As a consequence the watch can be kept accurate simply by making an adjustment such that the difference of rate between the horizontal positions and the right vertical position is as small as possible (the crown is on the right when the watch is in the vertical position).

The watch described has a movement rotating about its central axis. As a variant, it would also be possible to conceive of a watch whose movement is long and narrow and which would slide inside the case, or to devise a structure in which the movement rocks, as described in the documents referred to above.

1. A watch comprising:
a case defining a housing,
a movement arranged inside said housing,
display organs carried by said movement,
an assembly member connecting said movement to said case, and
a control system accessible from outside said case intended for correcting said display organs,
in which watch said assembly member allows said movement to be displaced with reference to said case, and said movement comprises a correcting mechanism for correcting said display organs,
said assembly member being so constructed that, in at least one predefined position of said watch, said movement occupies a defined position in its housing, and
said control system comprising:
a button accessible from outside said case and capable of being displaced by an application of pressure toward said movement, from an initial position,
a stem attached to said button and passing through said case, and
a connecting member designed to connect said button to the said correcting mechanism and constructed in such a way that, on the one hand, said stem is situated at a distance from said connecting member when said button is in said initial position and, on the other hand, said stem can be connected to said connecting member, in said defined position, in response to said application of pressure to said button.

2. The watch according to claim 1, wherein said assembly member is constructed in such a way as to allow said movement to rotate in its housing.

3. The watch according to claim 2, wherein said movement is of automatic type, its rotation winding up a driving spring.

4. The watch in according to claim 2, wherein said movement is encircled by a weighted ring and constructed in such a way as to define an eccentric mass causing said movement to rotate in its housing.

5. The watch according to claim 4, wherein said correcting mechanism comprises a hand-setting stem and wherein said connecting member comprises a connecting piece that is flush with said ring and has a flared portion such as to guide said stem attached to said button so that it engages in said connecting piece.

6. The watch according to claim 1, wherein said case has a tube, engaging with said button and with said stem attached to said button, and a seal, between said button and said tube, for sealing a passage of said stem through said case.
